(19) United States
(12) Patent Application Publication
(10) Pub. No.: US 2014/0047377 A1
(43) Pub. Date: Feb. 13, 2014

(54) RETRIEVING DATA FROM AN EXTERNAL DATA SOURCE

(71) Applicants: Karl-Peter Nos, Nussloch (DE); Dirk Baumgaertel, Hockenheim (DE)

(72) Inventors: Karl-Peter Nos, Nussloch (DE); Dirk Baumgaertel, Hockenheim (DE)

(73) Assignee: SAP AG, Walldorf (DE)

(21) Appl. No.: 13/570,893

(22) Filed: Aug. 9, 2012

(51) Int. Cl. G06F 3/048; G06F 15/16

(52) U.S. Cl. 715/781

(57) ABSTRACT

According to an example implementation, a method may include receiving metadata from a first external data source, the metadata indicating types of fields stored by the first external data source, generating a signal configured to cause a display to generate a metadata graphical user interface (GUI) presenting the types of fields to a user, receiving a signal indicating a selection of at least a first type of field and a second type of field by the user via the metadata GUI, receiving data from the first external data source, and converting a type of at least a first field of the received data into the first type and a type of at least a second field of the received data into the second type.

### TECHNICAL FIELD

This description relates to retrieving data from an external source.

### BACKGROUND

Data may be stored at multiple locations. Data may be stored in a local computing device that will perform operations on the data, as well as external sources. The external sources may store more data than needed to perform desired operations.

### SUMMARY

According to one general aspect, a method may include receiving metadata from a first external data source, the metadata indicating types of fields stored by the first external data source, generating a signal configured to cause a display to generate a metadata graphical user interface (GUI) presenting the types of fields to a user, receiving a signal indicating a selection of at least a first type of field and a second type of field by the user via the metadata GUI, receiving data from the first external data source, and converting a type of at least a first field of the received data into the first type and a type of at least a second field of the received data into the second type.

According to another general aspect, an apparatus may include at least one processor and at least one memory device. The at least one memory device may comprise instructions stored thereon that, when executed by the at least one processor, are configured to cause the apparatus to at least receive metadata from a first external data source, the metadata indicating types of fields stored by the first external data source, generate a signal configured to cause a display to generate a metadata graphical user interface (GUI) presenting the types of fields to a user, receive a signal indicating a selection of at least a first type of field and a second type of field by the user via the metadata GUI, receive data from the first external data source, and convert a type of at least a first field of the received data into the first type and a type of at least a second field of the received data into the second type.

According to another general aspect, a non-transitory computer-readable storage medium may include instructions stored thereon that, when executed by at least one processor, are configured to cause a computing system to at least receive metadata from a first external data source, the metadata indicating types of fields stored by the first external data source, generate a signal configured to cause a display to generate a metadata graphical user interface (GUI) presenting the types of fields to a user, receive a signal indicating a selection of at least a first type of field and a second type of field by the user via the metadata GUI, receive data from the first external data source, and convert a type of at least a first field of the received data into the first type and a type of at least a second field of the received data into the second type.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a server for selecting data according to an example implementation.

FIG. 2 is a timing diagram showing operations performed by the server, a client device, and external data sources according to an example implementation.

FIG. 3A is a diagram of a data graphical user interface (GUI) and a connection GUI according to an example implementation.

FIG. 3B is a diagram of the data GUI and a source GUI according to an example implementation.

FIG. 3C is a diagram of a metadata GUI according to an example implementation.

FIG. 4 is a diagram of a network environment including the server and external data sources according to an example implementation.

FIG. 5 is a diagram of the client device, server, and an external data source according to an example implementation.

### DETAILED DESCRIPTION

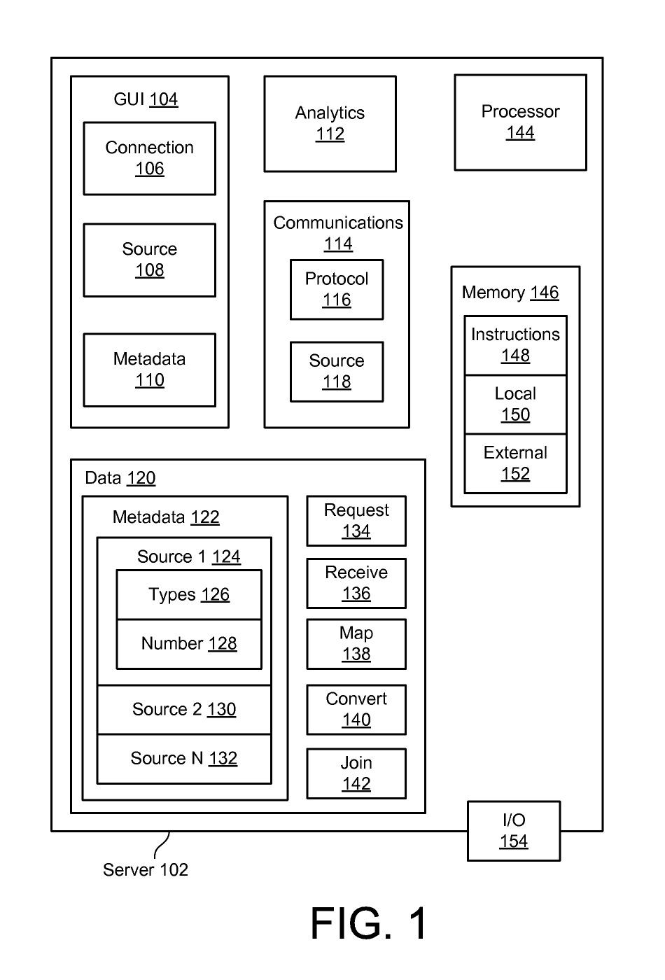

FIG. 1 is a block diagram of a server 102 for selecting data according to an example implementation. The server 102 may allow a user to select data, such as fields or types of data, to retrieve from an external data source(s), and perform analytics and generate reports using the data. The server 102 may communicate with external data sources to receive metadata, as well as data described by the metadata. The server 102 may also perform analytics on the received data as requested by a user.

The server 102 may retrieve only data desired by the user so as to minimize the use of computing resources to receive and store data. The server 102 may, for example, ask the user to select a connection type, to select external data sources from which to request data, and to select metadata such as types of fields. After the user has selected the metadata, the server 102 may request the data described by the metadata from the external data sources.

The server 102 may thereafter join the data received from the external data sources with data that are locally stored, and perform analytics on the joined data. Upon request by the user, the server 102 may perform analytics on the joined data and present reports to the user. As described herein, the server 102 may present information to the user by sending one or more signals to a local client device operated by the user, the one or more signals causing a display of the client device to present the information to the user, or may present the information to the user by sending one or more signals to a display coupled to the server, the one or more signals causing the display coupled to the server to present the information to the user. The server 102 may receive selections or input from the user via the client device, or directly from an input device coupled to the server 102.

The server 102 may include a graphical user interface (GUI) engine 104. The GUI engine 104 may generate instructions for the remote client device, or a local display coupled to the server 102, to generate GUIs for interaction with the user. The GUIs may present information to, and receive selections or other input from, the user.

The GUI engine 104 may include multiple GUI sub-engines. The GUI sub-engines may inherit properties of the GUI engine 104, or may be designed independently of the GUI engine 104. The GUI sub-engines may perform operations related to connections, sources, and/or metadata.

The GUI engine 104 may include a connection engine 106. The connection engine 106 may generate one or more instructions for generating a connection GUI. The connection GUI may interact with the user and allow the user to select a type of connection or protocol via which the server 102 will communicate with external data sources. The user may, for example, select Extensible Markup Language (XML) connections, Web Service connections, Hypertext Transfer Protocol (HTTP) connections, or Optimistic Distributed Protocol (ODP) connections. The server 102 may communicate via the selected connection type, and may, via a source engine GUI discussed below, present to the user external data sources capable of communicating with the server 102 via the selected connection type.

The GUI engine 104 may also include a source engine 108. The source engine 108 may generate one or more instructions for generating a source GUI. The source GUI may present available external data sources sources to the user, and receive a selection of one or more, or a plurality of, external data sources from the user. The source engine 108 may, for example, present external data sources capable of communicating with the server 102 via the connection type selected via the connection engine 106.

The GUI engine 104 may also include a metadata engine 110. After the user has selected the external data source(s), the metadata engine 110 may generate one or more instructions for generating a metadata GUI. The metadata GUI may present metadata to the user, such as types of fields. The types of fields may represent the types of data available from the external data sources to perform analytics on, such as dates, prices, number of items, item requests, item request fulfillments, locations, sales, quotes, or sales orders, as non-limiting examples. The metadata or types of fields may or may not also include types of data, such as integer variables, double or float variables, string variables, or Boolean variables, as non-limiting examples. The user may select the types of fields, such as sales orders or sales quotes. After the user has selected the metadata or types of fields, the server 102 may request the fields or data from the external data sources represented or indicated by the selected metadata.

The server 102 may also include an analytics engine 112. The analytics engine 112 may perform analytics or operations on the received data and/or data locally stored on the server 102. The analytics engine 112 may, for example, determine and provide averages, summaries, or to the user. The analytics engine 112 may provide the data to the user in the form of an analytics GUI generated based on instructions generated by the analytics engine 112. The analytics GUI may, for example, present possible operations to the user, and the user may select from among the presented operations. The analytics GUI may respond to the selection by sending the operations requests to the analytics engine 112 and presenting the reports received from the analytics engine 112 to the user.

The server 102 may also include a communications engine 114. The communications engine 114 may generate and process messages to communicate with external data sources in accordance with the selections by the user. The communications engine 114 may serve as a baseband processor for communicating with selected external data sources according to a selected communications protocol. For example, the communications engine 114 may include a protocol engine 116. The protocol engine 116 may engage in communications in accordance with the protocol selected by the user in the connection engine 106, such as a Web Service, HyperText Transfer Protocol (HTTP), or Optimistic Distributed Protocol (ODP). The communications engine 114 may also include a source engine 118. The source engine 118 may communicate with external sources in accordance with the selection by the user in the source GUI generated by the source engine 108.

The server 102 may also include a data engine 120. The data engine 120 may receive and process data from internal and external sources. The internal source(s) may include data stored in local memory of the server 102, and the external source(s) may include data received from external data source(s).

The data engine 120 may include a metadata engine 122. The metadata engine 122 may interact with one or more, or multiple, source engines such as a source engine 1 (124), source engine 2 (130), up to source N engine (132) to receive and process metadata. The source engines 124, 130, 132 may interact with external data sources from which the server 102 received metadata. While three source engines 124, 130, 132 are shown in FIG. 1, the data engine 120 and/or metadata engine 122 may interact with any number of external data sources which provide metadata.

The source engines 124, 130, 132 may include modules shown with respect to source engine 1 (124). For example, the source engine 1 (124) may include a type engine 126 and a number engine 128. The type engine 126 may process the types of fields indicated by the metadata sent by a first external data source. The number engine 128 may process and indicate the number of fields indicated by the metadata of the first external data source. Similar engines may perform similar functions within the other source engines 130, 132.

The data engine 120 may also include a request engine 134. The request engine 134 may generate requests for metadata and data from external data sources. The request engine 134 may generate requests for metadata from the external data source(s) selected by the user. The request engine 134 may generate requests for data based on the metadata such as field types selected by the user. For example, if the user selected sales orders and sales quotes, then the request engine 134 may generate requests for data representing sales orders and sales quotes from the selected data source(s).

The data engine 120 may also include a receive engine 136. The receive engine 136 may receive and process the metadata and data from the external data sources. The receive engine 136 may pass the received metadata and data to other modules within the server 102.

The data engine 120 may also include a mapping engine 138. The mapping engine 138 may map the received metadata to a common metadata model. For example, the mapping engine 138 may map each of, or some or all of, the types of fields or metadata received from external sources, into one or more of a plurality of common metadata types. The mapping engine 138 may, for example, store a set of common metadata types or common field types, and map the received metadata or field types to the stored metadata types or common field types.

The data engine 120 may also include a converting engine 140. The converting engine 140 may convert the received data into data types based on the metadata. For example, the server 102 may receive all of the data as fields with a single data type, such as string fields. The converting engine 140 may convert these fields, such as string fields, into data types as indicated by the metadata, such as amounts or dates.

The data engine 120 may also include a join engine 142. The join engine 142 may join the data received from multiple external data sources. The join engine 142 may, for example, join the data received from the external data sources with data with each other, and may join the data from the external data sources with local data, or data from local data sources.

The server 102 may include a processor 144. The processor 144 may be capable of executing instructions and performing functions and operations described herein. The processor 144 may, for example, include one or more microprocessors.

The server 102 may also include a memory 146. The memory 146 may include one or more memory devices. The memory 146 may include instructions 148, such as at least one non-transitory computer-readable storage medium comprising instructions stored thereon that, when executed by the processor 144, are configured to cause the server 102 to perform the functions and operations described herein.

The memory 146 may also store data. The memory 146 may, for example, include local data 150. The local data 150 may include data stored by the server 102 which may be repeatedly used by the server 102 to perform analytics. The memory 146 may also include external data 152. The external data 152 may include data received from external data sources.

The server 102 may also include one or more input/output (I/O) nodes 154. The input/output node(s) 154 may receive and send data from and to external sources. The input/output node(s) may convert messages from and to baseband signals, to and from signals capable of being transmitted via a desired medium such as such as a twisted pair, coaxial cable, optical fiber, or a wireless interface. The input/output node(s) 154 may include one or more communication ports, such as a twisted pair, coaxial cable, optical fiber, or antenna, via which the server 102 may communicate with the external data sources.

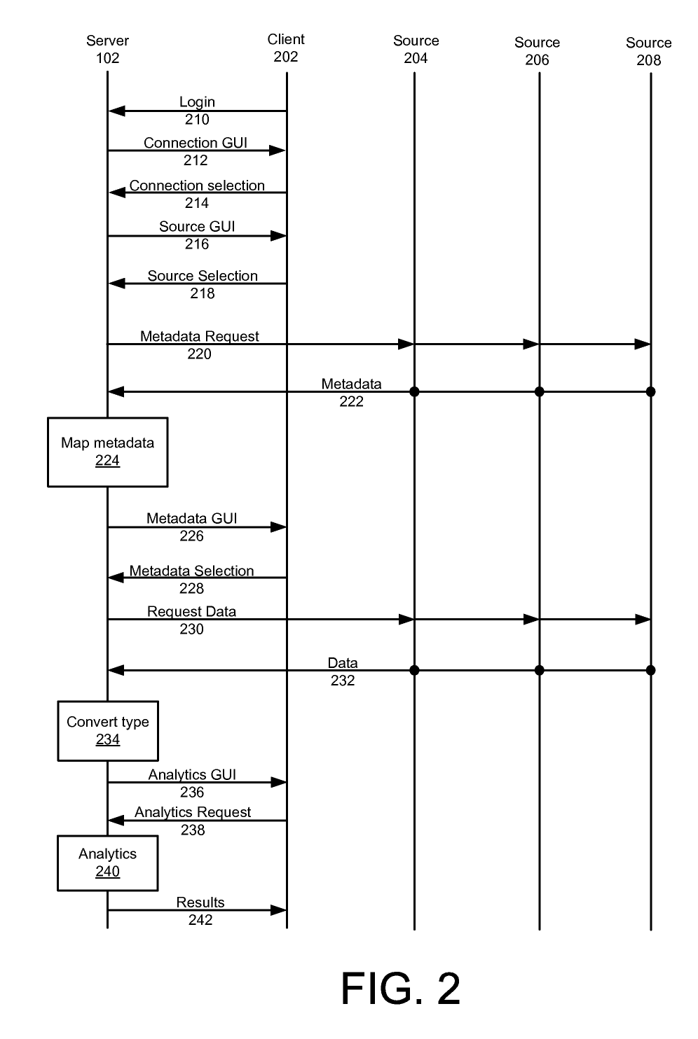

FIG. 2 is a timing diagram showing operations performed by the server 102, a client device 202, and external data sources 204, 206, 208 according to an example implementation. According to this example, a client 202 may log in to the server 102 (210). The client 202 may, for example, be a computing device such as a desktop computer, laptop or notebook computer, tablet computer, thin client, or smartphone operated by a user. The user may login (210) to the server 102 by entering a username and password into the client 202. The server 102 may respond to the login (210) by sending a connection graphical user interface (GUI) message 212 to the client 202. The connection GUI message 212 may include instructions embodied in one or more signals configured to cause a display of the client 202 to generate and display a connection GUI to the user.

The client 202 may display the connection GUI to the user. The connection GUI may present available connection types to the user.

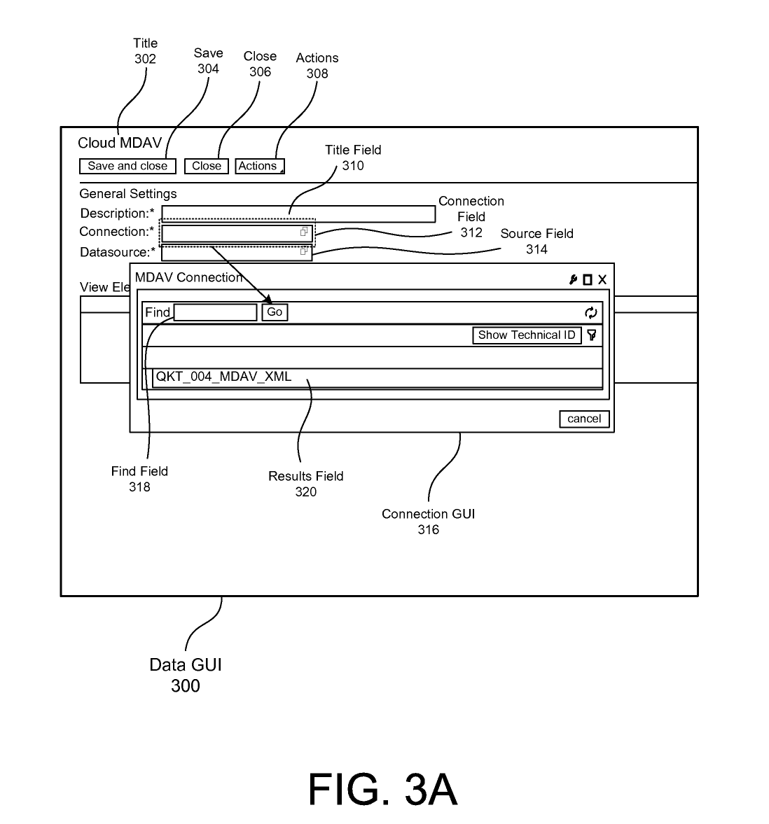

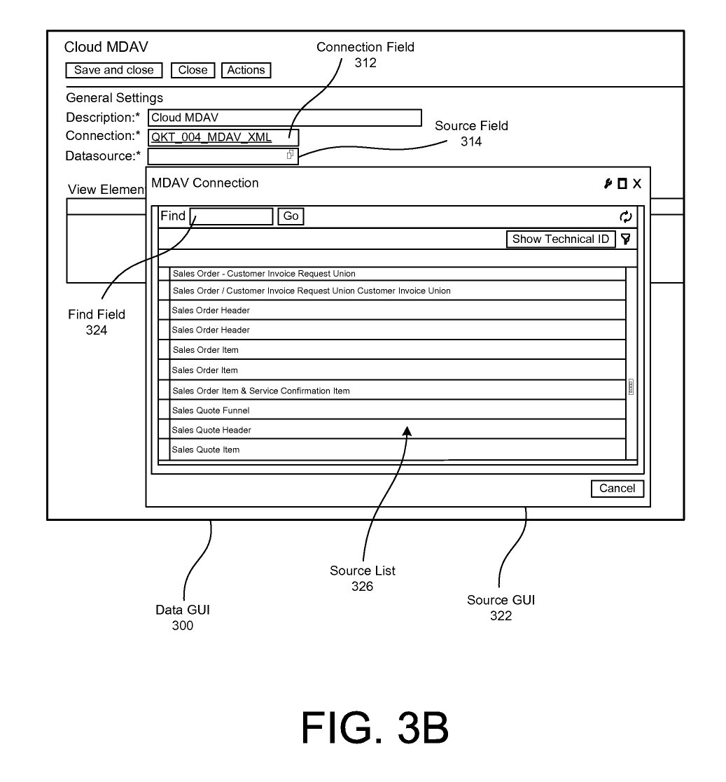

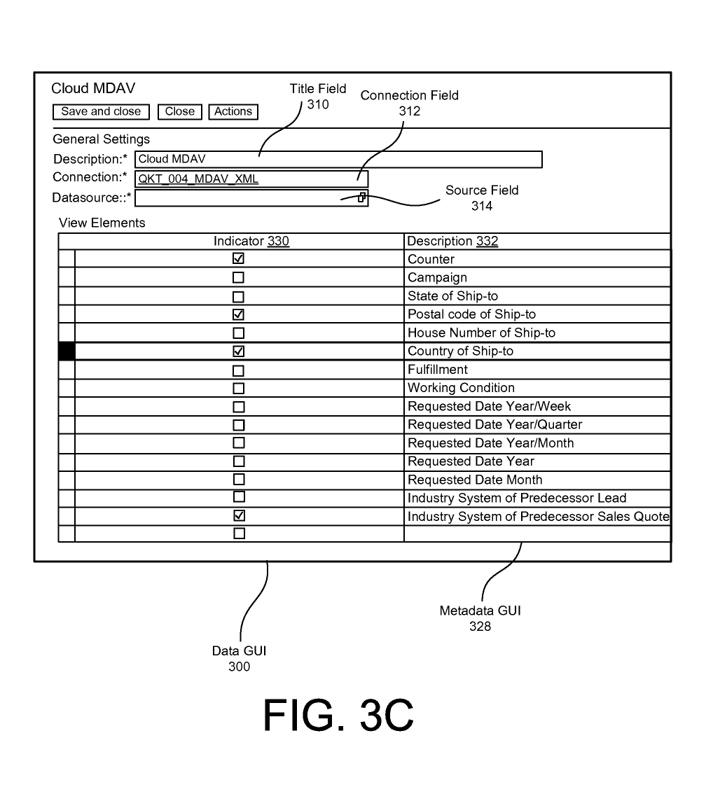

FIG. 3A is a diagram of a data graphical user interface (GUI) 300 and a connection graphical user interface (GUI) 316 according to an example implementation. The client 202 may display the data GUI 300 and connection GUI 316, and may receive input from the user via the data GUI 300 and connection GUI 316. The data GUI 300 may be capable of representing multiple GUIs such as the connection GUI, a source GUI (shown in FIG. 3B), and a metadata GUI (shown in FIG. 3C).

The data GUI 300 may include a title 302. The title 302 may indicate the type of operations to be performed, or may indicate a name of a project or report. The data GUI 300 may also include a save button 304. The save button 304 may respond to a user click by saving any selections or other input made by the user, allowing the user to save his or her work and resume making selections later. The data GUI 300 may also include a close button 306. The close button 306 may respond to a user click by closing the data GUI 300. The data GUI 300 may also include an action button 308. The server 102 may respond to the user clicking on the action button 308 by synchronizing and/or updating a proxy object. Updating the proxy object may update the metadata recognized by the server 102 to synchronize any changes in the metadata in the external data source(s) 204, 206, 208.

The data GUI 300 may include a title field 310. The title field 310 may receive user input, such as text input, allowing the user to type in a title for the project. The data GUI 300 may replicate the entry into the title field 310 into the title 302.

The data GUI 300 may include a connection field 312. The connection field 312 may respond to selection by the user, or a user click, by generating the connection GUI 316.

The connection GUI 316 may include a find field 318. The find field 318 may receive a search term from the user. The connection GUI 316 may respond to receiving the search term by presenting the user with connection types that match or are similar to the received search term.

The connection GUI 316 may include a results field 320. The results field 320 may show available connection types based on input received in the find field 318. In the example shown in FIG. 3A, the results field shows QKT_{—}004_MDAV_XML as an available connection type. The results field 320 may also allow the user to select one or more of the available connections to find external data sources. The server 102 may respond to the user selecting an available connection(s) by presenting external data sources which may communicate with the server 102 via the selected connection type or protocol.

The data GUI 300 may also include a source field 314. After the user has selected an available connection(s), the data GUI 300 may present available external data sources to the user. The data GUI 300 may present a source graphical user interface (GUI), shown and described with respect to FIG. 3B, in response to the user selecting a connection type, or in response to the user clicking on the source field 314.

Returning to FIG. 2, the client 202 may respond to the user's selection of a connection type by sending the connection selection 214 to the server 102. In response to receiving the connection selection 214, the server 102 may send a source graphical user interface (GUI) message 216 to the client 202. The source GUI message 216 may include instructions embodied in one or more signals configured to cause a display of the client 202 to generate and display a source GUI to the user. The client 202 may generate the source GUI to the user and receive a selection of one or more external data sources.

FIG. 3B is a diagram of the data GUI 300 and a source graphical user interface (GUI) 322 according to an example implementation. The data GUI 300 may include the source field 314. The data GUI 300 may respond to the user selecting a connection type, or clicking on the source field 314, by generating the source GUI 322.

The source GUI 322 may include a find field 324. The find field 324 may receive text entries from the user. The source GUI 322 may respond to text entries into the find field 324 by searching for external data sources which store data with the entered term. In the example shown in FIG. 3B, the user has entered ‘sales’ into the find field 324. The source GUI 322 may include a source list 326. The source list 326 may display source types based on the entry into the find field 324. The source list 326 may display available external data sources to the user. The user may select one or more, or multiple, external data sources from the source list 326.

Returning to FIG. 2, upon receiving the selection of the one or more external data sources, the client 202 may send a source selection message 218 to the server 102. The source selection message 218 may identify the external data source(s) selected by the user.

Upon receipt of the source selection, the server 102 may send a metadata request message 220 to the selected external data sources 204, 206, 208. In this example, the external data sources 204, 206, 208 were selected by the user in the source GUI 322 shown in FIG. 3B. While the metadata request message 220 is shown as single message in FIG. 2, the request may be comprised of multiple messages and/or signals sent at different times or sent at a same time.

In response to the receiving the metadata request message 220, the external data sources 204, 206, 208 may send metadata 222 to the server 102. While the metadata 222 is shown in FIG. 2 as being sent at a same time by the external data sources 204, 206, 208, the external data sources 204, 206, 208 may send their respective metadata separately, at either different times or a same time.

The metadata 222 may indicate types of fields for data stored by the external data sources 204, 206, 208, and may also indicate a number of each of the fields. The metadata 222 may thereby describe the data stored by each of the external data sources 204, 206, 208.

Upon receipt of the metadata 222, the server 102 may map the metadata 222 to a common metadata model (224). The server 104 may, for example, map the field types indicated by the metadata 222 to predetermined field types which the server 102 is configured to process. Mapping the metadata 222 to the common metadata model (224) may facilitate consistency in presenting the field types of the data stored by the external data sources 204, 206, 208 to the user. In the following example, fifteen predetermined field types (“CONSTANTS”) are assigned integer values.

| CONSTANTS: | BEGIN OF gc_cloud_data_type, | |
|---|---|---|
| amount | TYPE ty_cloud_data_type | VALUE ‘1’, |
| quantity | TYPE ty_cloud_data_type | VALUE ‘2’, |
| month_id | TYPE ty_cloud_data_type | VALUE ‘3’, |
| quarter_id | TYPE ty_cloud_data_type | VALUE ‘4’, |
| week_id | TYPE ty_cloud_data_type | VALUE ‘5’, |
| year_id | TYPE ty_cloud_data_type | VALUE ‘6’, |
| year_month_id | TYPE ty_cloud_data_type | VALUE ‘7’, |
| year_quarter_id | TYPE ty_cloud_data_type | VALUE ‘8’, |
| year_week_id | TYPE ty_cloud_data_type | VALUE ‘9’, |
| date | TYPE ty_cloud_data_type | VALUE ‘10’, |
| currency | TYPE ty_cloud_data_type | VALUE ‘11’, |
| unit | TYPE ty_cloud_data_type | VALUE ‘12’, |
| integer | TYPE ty_cloud_data_type | VALUE ‘13’, |
| float | TYPE ty_cloud_data_type | VALUE ‘14’, |
| uuid | TYPE ty_cloud_data_type | VALUE ‘15’, |
| time | TYPE ty_cloud_data_type | VALUE ‘16’, |

END OF gc_cloud_data_type.

The external data sources 204, 206, 208 may perform mapping of their particular field types to integer values of the common metadata model, and send the values (for example, 1, 2, 3 . . . 16) to the server 102, and the server 102 may map the received integer values to the predetermined field types, or the server 102 may receive the field types from the external data sources 204, 206, 208 in the format stored locally by the external data sources, and the server 102 may, where possible, map the received field types to the field types in the common metadata model.

After receiving and mapping the metadata (224), the server 102 may send a metadata graphical user interface (GUI) message 226 to the client 202. The metadata GUI message 226 may include instructions configured to cause the client 202 to generate and present metadata GUI to the user, and may include the field types received from the external data sources 204, 206, 208. The metadata GUI may display the field types to the user, and receive a selection of one or more field types that represent types of data based on which the user wishes to have analytics performed.

FIG. 3C is a diagram of a metadata GUI 328 according to an example implementation. The metadata GUI 328 may be included in the data GUI 300. The metadata GUI 328 may include descriptions of field types, and an option to select one or more, or a plurality of, field types. The metadata GUI 328 may show field types based on the metadata received from the external data sources 204, 206, 208, either according to the local descriptions of the field types within the external data sources 204, 206, 208, or according to the field types of the common metadata model.

In this example, the metadata GUI 328 may include an indicator column 330 and a description column 332. The description column 332 may include descriptions of the available field types. The indicator column 330 may include check boxes or other interfaces to receive selections from the user for each of the descriptions associated with the check boxes or other interfaces. The user may check the boxes in the indicator column 330 to select the field types displayed in the description column 332 that the user wishes the server 102 to use to perform analytics. The selection of the field types may cause the server 102 to request data matching those field types from the external data sources 204, 206, 208, and the server 102 may later perform analytics on the data corresponding to those field types.

Returning to FIG. 2, upon receiving the selection of the fields, the client 202 may send a metadata selection message 228 to the server 102. The metadata selection message 228 may indicate the field types selected by the user in the metadata GUI 328. In response to receiving the metadata selection message 228, the server 102 may send request data messages 230 to the external data sources 204, 206, 208. While FIG. 2 shows the request data message 230 as a single signal or message sent to the external data sources 204, 206, 208, request data messages 230 may be sent separately to each of the external data sources 204, 206, 208, either at a same time or at different times. In response to receiving the request data message(s) 230, the external data sources 204, 206, 208 may send their respective data messages 232 to the server 102. The data 232 sent to the server 102 by the external data sources 204, 206, 208 may be the data stored in the fields described by the field types selected by the user in the metadata GUI 328.

The data 232 received by the server 102 from the external data sources 204, 206, 208 may be of a single type, with no differentiation based on the types of data or information represented by the data 232. For example, the data 232 may all be in the form of string variables or alphanumeric text.

In order to make the data 232 meaningful for performing operations such as analytics and generating reports, the server 102 may, in response to receiving the data 232, convert the types of the data (234). The server 102 may convert the types by converting the received fields into the types of fields indicated by the metadata selections of the user, the metadata 222, and the mapping of the metadata (224). For example, the server 102 may convert the data from string variables into different types of variables such as integers, dates, decimals, or other types of data.

After converting the type(s) (234), the server 102 may have the raw data upon which to perform analytics. The server 102 may send an analytics graphical user interface (GUI) message 236 to the client 202. The analytics GUI message 236 may include instructions configured to cause the client 202 to generate and display an analytics GUI to the user.

Based on receiving the analytics GUI message 236, the client 202 may generate and display an analytics GUI (not shown) to the user. The user may select analytics to be performed on the data via the analytics GUI. The user may, for example, select operations to be performed and/or reports to be generated based on the data. After receiving the operation and report requests from the user via the analytics GUI, the client 202 may send an analytics request message 238 to the server 102. The analytics request message 238 may indicate the operations and/or reports to be performed or generated. In response to receiving the analytics request message 238, the server 102 may perform analytics (240) on the data. The server 102 may also generate reports based on the performing the analytics. After performing the analytics (240) and/or generating the reports, the server 102 may send the results 242 to the client 202, and the client 202 may display the results 242 to the user.

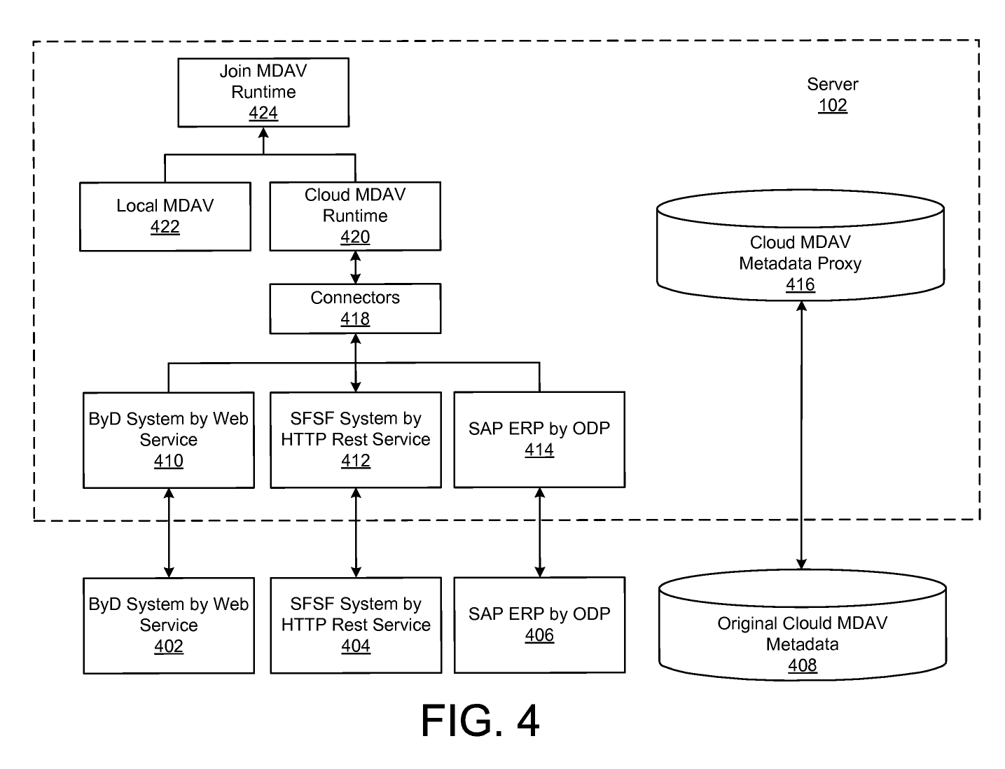

FIG. 4 is a diagram of a network environment including the server 102 and external data sources according to an example implementation. In this example, the external data sources may include a ByDesign (ByD) System by Web Service 402, a Success Factors (SFSF) System by Hypertext Transfer Protocol (HTTP) Rest Service 404, and a SAP Enterprise Resource Planning (ERP) by Optimistic Distributed Protocol (ODP) 406. The server 102 may request the metadata 408, such as field types, from the external data sources 402, 404, 406. The received metadata 408 may be stored in the server as a cloud multidimensional analytical view (MDAV) metadata proxy 416. After receipt of the metadata, the server 102 may request the data represented by the field types. The data may be received via connections indicated within the data sources, such as a Web Service for the ByD System by Web Service 402, HTTP for the SFSF System by HTTP Rest Service 404, and ODP for the SAP ERP by ODP 406, which may be received and/or stored within the corresponding external data source engines 410, 412, 414 (which may correspond to the source engines 124, 130, 132 shown in FIG. 1). The engines 410, 412, 414 may send the received data to a connectors source 418, which may serve as an interface between the source engines 410, 412, 414 and Cloud MDAV Runtime 420. The data in the connectors 418 may be joined together at runtime in the Cloud MDAV Runtime 420. The server 102 may also store the local data 422. At runtime, the server 102 may join the local data 422 with the external data (424), and prepare the data for analytics operations and reports.

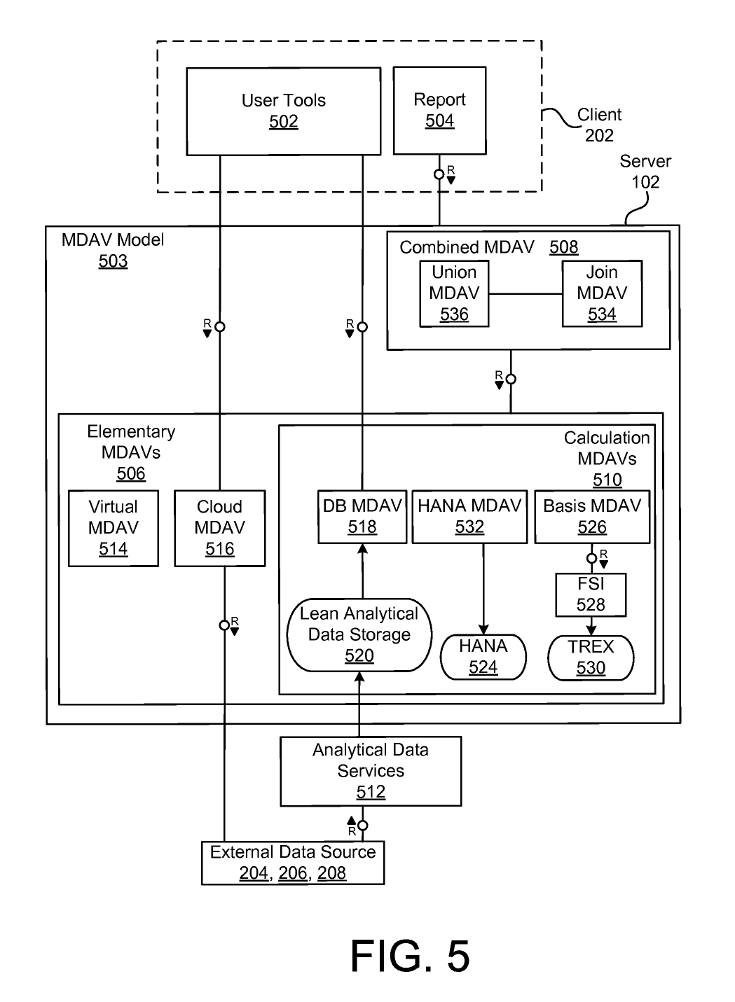

FIG. 5 is a diagram of the client device 202, server 102, and an external data source 204, 206, 208 according to an example implementation. The client device 202 may include user tools 502. The user tools 502 may enable the user to specify the data to be retrieved and the operations to be performed on the retrieved data. The user tools 502 may include, for example, the data GUI 300, connection GUI 316, source GUI 322, metadata GUI 328, and/or analytics GUI.

The client 202 may send the request(s) to a multidimensional analytical view (MDAV) model 503 of the server 102. The MDAVs described herein may include a list of fields, a number of fields, and/or characteristics of fields, in a database or data source. An MDAV may also include a database table or a union of two MDAVs. The MDAV model 503 may include elementary MDAVs 506 and combined MDAVs 508. The elementary MDAVs 506 may include a virtual MDAV 514, a cloud MDAV 516, and calculation MDAVs 510. The virtual MDAV 514 may include coding or instructions for the database(s) and fields. The cloud MDAV 516 may connect to, such as by sending requests to, the external data sources 204, 206, 208. The cloud MDAV 516 may send the data requests to the external data sources 204, 206, 208 based on the user's selections in the user tools 502, such as the user's selections of field types.

The calculation MDAV 510 may include a MDAV database 518, a high-performance analytic (HANA) MDAV 532, and a basis MDAV 526. The database MDAV 518 may receive data from the external data sources 204, 206, 208 based on the requested field types. The MDAV database 518 may receive the data from the external data sources via a lean analytical data storage module 520. The lean analytical data storage module 520 may store the data received from the external data sources 204, 206, 208 based on the requests for specific field types. The lean analytical data storage module 520 may store the data efficiently by storing only the requested data types, which will likely be used to perform analytics and generate reports. The lean analytical data storage module 520 may receive the data from the external data sources 204, 206, 208 via analytical data services 512. The analytical data services 512 may perform analytics on the requested data, or may perform operations such as converting field types into the common metadata model, according to example implementations.

The HANA MDAV 532 may serve as a HANA database, storing Structured Query Language (SQL) data and column-based statements. A HANA module 524 may perform high-performance analytics on both the data received from the external data sources 204, 206, 208 and locally stored data.

The basis MDAV 526 may connect to the MDAV database 518 and provide the data to a fast search infrastructure (FSI) 528. The FSI 528 may facilitate quick searching on the data, and provide the data to a TREX search engine 530. The TREX 530 may provide an index for sorting data in the MDAV database 518, and may create duplicate or second records of the data.

The elementary MDAVs 506 may provide the data to a combined MDAV 508. The combined MDAV 508 may include a union MDAV 536 and a join MDAV 534. The union MDAV 532 may unite the data received from the external data sources 204, 206, 208. After the union MDAV 536 has united the data received from the external data sources 204, 206, 208, the join MDAV 534 may join the united data with locally stored data. The server 102 may perform analytics and generate reports based on the united and joined data.

The client 202 may show the reports 504 to the user. The client 202 may show the reports 504 to the user via a user interface on a display of the client 202. The report 504 may show the results of calculations based on variables and data provided by the server 102.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or computer-readable storage medium, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
receiving metadata from a first external data source, the metadata indicating types of fields stored by the first external data source;
generating a signal configured to cause a display to generate a metadata graphical user interface (GUI) presenting the types of fields to a user;
receiving a signal indicating a selection of at least a first type of field and a second type of field by the user via the metadata GUI;
receiving data from the first external data source; and
converting a type of at least a first field of the received data into the first type and a type of at least a second field of the received data into the second type.

2. The method of claim 1, wherein the receiving the metadata includes receiving the metadata from the first external data source, the metadata indicating the types of fields and a number of fields stored by the first external data source.

3. The method of claim 1, wherein the receiving the data includes receiving the data in a plurality of fields, all of the plurality of fields having a same type.

4. The method of claim 1, wherein the receiving the data includes receiving the data in a plurality of fields, all of the plurality of fields being string fields.

5. The method of claim 1, further comprising:
generating a signal configured to cause the display to generate a source GUI presenting available data sources to the user;
receiving a signal indicating a selection of the first external data source by the user via the source GUI; and
requesting the metadata from the first external data source based on the signal indicating the selection of the external data source.

6. The method of claim 1, further comprising joining at least the first converted field and the second converted field with fields from a local data source.

7. The method of claim 1, further comprising:
generating a signal configured to cause the display to generate a connection GUI requesting a selection of a connection type by the user;
wherein the receiving the metadata includes receiving the metadata from the first external data source using the selected connection type; and
wherein the receiving the data includes receiving the data from the first external data source using the selected connection type.

8. The method of claim 1, further comprising:
mapping the types of fields indicated by the metadata received from the first external data source into predetermined field types;
wherein the converting the type includes converting the type of at least the first field of the received data into a first predetermined field type and converting the type of at least the second field of the received data into a second predetermined field type.

9. The method of claim 1, further comprising:
receiving metadata from a second external data source; and
receiving data from the second external data source.

10. An apparatus comprising:
at least one processor; and
at least one memory device comprising instructions stored thereon that, when executed by the at least one processor, are configured to cause the apparatus to at least:
receive metadata from a first external data source, the metadata indicating types of fields stored by the first external data source;
generate a signal configured to cause a display to generate a metadata graphical user interface (GUI) presenting the types of fields to a user;
receive a signal indicating a selection of at least a first type of field and a second type of field by the user via the metadata GUI;
receive data from the first external data source; and
convert a type of at least a first field of the received data into the first type and a type of at least a second field of the received data into the second type.

11. The apparatus of claim 10, wherein the receiving the metadata includes receiving the metadata from the first external data source, the metadata indicating the types of fields and a number of fields stored by the first external data source.

12. The apparatus of claim 10, wherein the receiving the data includes receiving the data in a plurality of fields, all of the plurality of fields having a same type.

13. The apparatus of claim 10, wherein the receiving the data includes receiving the data in a plurality of fields, all of the plurality of fields being string fields.

14. The apparatus of claim 10, wherein the instructions are further configured to cause the apparatus to:
generate a signal configured to cause the display to generate a source GUI presenting available data sources to the user; and
receive a signal indicating a selection of the first external data source by the user via the source GUI; and
requesting the metadata from the first external data source based on the signal indicating the selection of the external data source.

15. The apparatus of claim 10, wherein the instructions are further configured to cause the apparatus to join at least the first converted field and the second converted field with fields from a local data source.

16. The apparatus of claim 10, wherein the instructions are further configured to cause the apparatus to:
generate a signal configured to cause the display to generate a connection GUI requesting a selection of a connection type by the user;
wherein the receiving the metadata includes receiving the metadata from the first external data source using the selected connection type; and
wherein the receiving the data includes receiving the data from the first external data source using the selected connection type.

17. The apparatus of claim 10, wherein the instructions are further configured to cause the apparatus to:
map the types of fields indicated by the metadata received from the first external data source into predetermined field types;
wherein the converting the type includes converting the type of at least a first field of the received data into the first predetermined field type and converting the type of at least a second field of the received data into the second predetermined field type.

18. A computer-readable storage medium comprising instructions stored thereon that, when executed by at least one processor, are configured to cause a computing system to at least:
receive metadata from a first external data source, the metadata indicating types of fields stored by the first external data source;
generate a signal configured to cause a display to generate a metadata graphical user interface (GUI) presenting the types of fields to a user;
receive a signal indicating a selection of at least a first type of field and a second type of field by the user via the metadata GUI;
receive data from the first external data source; and
convert a type of at least a first field of the received data into the first type and a type of at least a second field of the received data into the second type.

19. The computer-readable storage medium of claim 18, wherein the instructions are further configured to cause the computing system to:
generate a signal configured to cause the display to generate a source GUI presenting available data sources to the user; and
receive a signal indicating a selection of the first external data source by the user via the source GUI; and
requesting the metadata from the first external data source based on the signal indicating the selection of the external data source.

20. The computer-readable storage medium of claim 18, wherein the instructions are further configured to cause the computing system to:
map the types of fields indicated by the metadata received from the first external data source into predetermined field types;
wherein the converting the type includes converting the type of at least a first field of the received data into the first predetermined field type and converting the type of at least a second field of the received data into the second predetermined field type.
